(19) United States
(12) Patent Application Publication
(10) Pub. No.: US 2019/0387300 A1
(43) Pub. Date: Dec. 19, 2019

(54) A HEARING DEVICE HOUSING, A HEARING DEVICE AND A METHOD FOR MANUFACTURING A HEARING DEVICE HOUSING

(71) Applicant: Sonova AG, Stäfa (CH)

(72) Inventors: Natasha THUMM, Wetzikon (CH); Jana-Kosima Schwarzlos-Sooprayen, Stäfa (CH); Erdal Karamuk, Männedorf (CH); Patrizia Richner, Männedorf (CH)

(21) Appl. No.: 16/487,958

(22) PCT Filed: Feb. 23, 2017
(86) PCT No.: PCT/EP2017/054181

§ 371 Date: Aug. 22, 2019

(51) Int. Cl. H04R 1/10; B23K 26/34

(52) U.S. Cl. CPC H04R 1/1016; H04R 1/1058; H04R 2201/105; H04R 2225/025; B23K 26/34

(57) ABSTRACT

The present invention relates to a hearing device housing (12) comprising titanium. The arithmetical mean roughness of the housing surface is Ra=0.7-1.8 μm according to DIN EN ISO 4287/DIN EN ISO 4288. The proposed hearing device housing (12) provides improved effects on retention and wearing comfort. Performance during insertion and removal of the hearing device housing (12) is improved.

### TECHNICAL FIELD

The present invention is related to a hearing device housing, a hearing device and a method of manufacturing a hearing device housing.

### BACKGROUND OF THE INVENTION

Hearing devices are typically used to improve the hearing capability or communication capability of a user. A hearing device may pick up the surrounding sound with a microphone of the hearing device, processing the microphone signal thereby taking into account the hearing preferences of the user of the hearing device and providing the processed sound signal into a hearing canal of the user via a miniature loudspeaker, commonly referred to as a receiver. A hearing device may also receive sound from an alternative input such as an induction coil or a wireless interface. A hearing device may be a hearing protection device. A hearing device may be an earphone.

A hearing device comprises a housing. If the hearing device is an In-The-Ear hearing device (ITE) or a custom shaped earpiece, the housing is individually formed to fit into an ear canal of a user.

ITE's are known which can be equipped with a module rather than a faceplate. The module can comprise components such as a frame, battery door and electrical and mechanical parts, etc. The module can be mounted to the hearing device housing by inserting the module into an opening formed into the housing. The module can be releasably mounted to the hearing device housing by e.g. using a click-in mechanism, sealing, etc. In case of the hearing device is prepared to be equipped with a module, prior to the assembly, the hearing device housing can be processed, e.g. by means of surface finishing. If the hearing device comprises a custom shaped earpiece, the housing comprises an opening which for example allows insertion of a receiver or a sound tube.

In the state of the art, hearing devices are known, e.g. In-the-Ear (ITE) hearing devices, comprising additively manufactured housings which are made of e.g. acrylic materials. After additive manufacturing, a lacquer can be applied to the housings to ensure biocompatibility and enhance the visual appearance. However, the surface roughness of the housing applied with lacquer cannot be chosen at will.

Recently, in the technical field of medical devices, using titanium as material of the housings is getting more popular. The surface treatment of the housings is a known procedure in order to reach specific properties and improve biocompatibility, e.g. by processing surfaces that promote the attachment or integration of tissue into an implant. As for the technical field of hearing devices, using titanium as a material for manufacturing components, custom shaped hearing device housings or earpieces, is challenging. In the prior art, it is known to add a coating to the titanium made housing in order to control friction or rather retention and therefore the ability of the hearing device housing to safely stay in place in the ear canal. However, this process can forfeit the inherent biocompatibility of the titanium alloy and can result in increased costs and reduced precision.

In order to e.g. improve acoustic coupling in hearing devices, the custom shaped hearing device housings can be manufactured from metal powder using a Selective Laser Melting (SLM) technology, wherein the metal powder can comprise titanium powder.

In the technical field of custom shaped hearing device housings and earpieces, it is a problem to achieve sufficient retention, e.g. the ability of the hearing device housing to safely stay in place in the ear canal of a user even in case of movements of the jaw or the head. It is a problem to achieve adequate retention in custom shaped hearing device housings and earpieces since different factors are contributing to an optimal fit. Said factors comprise e.g. curvature of the ear canal, size of the hearing device housing, availability of total contact area, radial pressure on the ear canal, e.g. by inserting a housing which is larger than the ear canal in a relaxed state, friction between the housing and the ear canal, etc.

Document DE 102012015496 A1 describes a housing for an earphone that is at least partially made by metal-injection-molding (MIM) of e.g. titanium. Several surface finishes as post treatment of the raw MIM part are described. Document DE 102008062844 B3 describes an earpiece for hearing instruments that is based on braided metal wires or a thin-walled tubular metal part that can be of e.g. titanium among other materials. Several surface treatments such as mechanical polishing or electropolishing are mentioned. Document EP 2 130 402 B1 describes a procedure for optimally orienting an earmold or shell on the building platform for a SLM process in order to minimize the surface defects and optimize the build precision. Post processing of the surface by e.g. vibratory grinding is also mentioned.

It is an object of the present invention to overcome the drawbacks known in the prior art.

### SUMMARY OF THE INVENTION

The present invention is directed to a hearing device housing comprising titanium, wherein the arithmetical mean roughness of the housing surface is Ra=0.7-1.8 μm according to DIN EN ISO 4287/DIN EN ISO 4288. The present invention provides a hearing device housing presenting improved effects on retention and wearing comfort. Further, the inventive hearing device housing presents e.g. a better wearing comfort with and without jaw movement, better performance during insertion and removal of the shell, etc.

The hearing device housing according to the present invention achieves an optimal balance between retention, wearing comfort and acoustic sealing. Contrary to the prior art, application of lacquer to the surface of the hearing device housing can be omitted. Therefore, the opportunity to engineer the surface roughness of the final product to best fit the customer's needs is improved.

The biocompatible nature of the titanium made hearing device housing according the present invention allows to wear a non-lacquered hearing device housing. Advantageously, a new degree of freedom of the surface roughness is allowed.

Advantageously, the surface roughness of the inventive hearing device housing impacts on e.g. the following aspects:
Ease of insertion/removal: The hearing device needs to be insertable/removable without causing irritation or discomfort.
Retention: As the contact area of the titanium hearing device housing with the ear canal is small, increased surface roughness will enhance retention.
Aesthetics: While slightly rough surfaces are desired to conceal surface imperfections from the additive manufacturing (printing) process, they are also more prone to discoloration due to e.g. residues of skin fat and cerumen.

In an embodiment of the proposed hearing device housing the housing surface is surface-treated by means of vibratory grinding. The process of vibratory grinding can be performed by using abrasive media selected such to simultaneously allow scalable grinding of a plurality of hearing device housing. Therefore, process throughput is increased resulting in reduced costs.

Moreover, the present invention is directed to a hearing device comprising a hearing device housing according to claim 1 or 2. The inventive hearing device presents improved retention. Therefore, once inserted into the ear canal of the user, the hearing device safely stays in place even through movements of the jaw or the head.

Moreover, the present invention is directed to a method of manufacturing a hearing device housing. The method comprises the steps of: designing a pre-model of the hearing device housing by means of a 3D-modelling software, producing from a metal powder comprising titanium a preform of the hearing device housing based on the pre-model, and surface-treating the hearing device housing surface such that the arithmetical mean roughness is Ra=0.7-1.8 μm according to DIN EN ISO 4287/DIN EN ISO 4288.

The inventive method allows to manufacture a hearing device housing which achieves an optimal balance between retention, wearing comfort and acoustic sealing. Advantageously, this optimal balance is achieved without applying lacquer to the hearing device housing. Further, the surface roughness of the manufactured hearing device housing can be controlled such to best fit the customer's needs.

In an embodiment of the proposed method the producing step comprises selective laser melting SLM.

In an embodiment of the proposed method the surface-treating step comprises vibratory grinding. The vibratory grinding allows surface-treating of a plurality of hearing device housings, simultaneously, without loss of quality.

In an embodiment of the proposed method the surface-treating step further comprises sand blasting. Sand blasting media may comprise steel shot, steel grit, glass bead, crushed glass, aluminium oxide, silicon carbide, corundum, plastic, walnut shell, corn cob, baking soda, ceramic grit, copper slag.

It is expressly pointed out that any combination of the above-mentioned embodiments is subject of further possible embodiments. Only those embodiments are excluded that would result in a contradiction.

### BRIEF DESCRIPTION OF THE DRAWINGS

The present invention is further described with reference to the accompanying drawings jointly illustrating various exemplary embodiments which are to be considered in connection with the following detailed description. What is shown in the FIGURE is:

FIG. 1 is a perspective view of a hearing device comprising a module received into a housing.

### DETAILED DESCRIPTION OF THE INVENTION

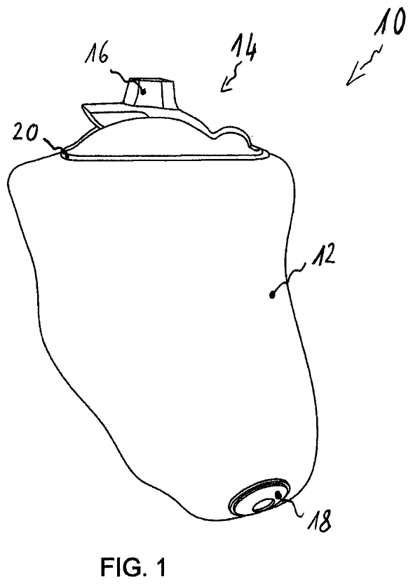

FIG. 1 depicts a hearing device 10 in a perspective view. The hearing device 10 is an In-The-Ear (ITE) hearing device. Of course, other hearing device types can be used, as well. In the shown example, the housing 12 of the hearing device 10 is made of titanium. One of a plurality of advantages in using titanium is the ability of creating housings which are very thin while still showing increased strength. Further, biocompatibility of the titanium made housing 12 is improved. The hearing device 10 further comprises a module 14 which is inserted into an opening formed into the hearing device housing 12. The module 14 can be a pre-assembled component comprising a battery compartment which openable end thereof is for receiving a battery (not shown). The openable end can be opened and closed via a battery door 16. The FIG. 1 shows the battery door 16 being closed. The battery door 16 can be opened to exchange a used battery as well as for service, maintenance, etc. Next to the battery, the module 14 can further comprise at least one microphone, a GMR switch, processing means, etc. The module 14 can be easily pre-assembled to the hearing device housing 12. The hearing device 10 further comprises a sound outlet 18 for outputting sound from a receiver (not shown) of the hearing device 10 to the ear canal of the user. The module 14 comprises an outer rim 20 which abuts against the periphery of an opening of the hearing device housing 12 once inserted.

The hearing device housing 12 comprises titanium. The arithmetical mean roughness of the surface of the hearing device housing 12 is Ra=0.7-1.8 μm according to DIN EN ISO 4287/DIN EN ISO 4288. In an aspect, the hearing device housing 12 is manufactured by the steps of: designing a pre-model of the hearing device housing by means of a 3D-modelling software, producing from a metal powder comprising titanium a preform of the hearing device housing based on the pre-model, and surface-treating the surface of the hearing device housing 12 such that the arithmetical mean roughness is Ra=0.7-1.8 μm according to DIN EN ISO 4287/DIN EN ISO 4288.

The producing step can comprise selective laser melting SLM. The surface-treating step to achieve the surface roughness can e.g. comprise vibratory grinding, manual surface treating. Additionally, a process using sandblasting, can be used for further surface finishing. Further, polishing, chemical etching, electro-chemical processes, e.g. anodizing, can be applied to the hearing device housing 12.

The surface of the hearing device housing 12 is treated such that the roughness thereof is in a range of Ra=0.7-1.8 μm according to DIN EN ISO 4287/DIN EN ISO 4288. Therefore, the hearing device housing 12 achieves improved retention in the ear canal of the user. It has been shown that the proposed range of Ra=0.7-1.8 μm according to DIN EN ISO 4287/DIN EN ISO 4288 proves to be an optimum range. The selected range of roughness can achieve an optimal balance between various requirements of e.g. retention, ease of insertion/removal (wearing comfort), aesthetics, acoustic sealing.

Further, the requirement of applying lacquer onto the surface of the hearing device housing 12 can be eliminated. This can offer the opportunity to engineer the surface roughness of the hearing device housing 12 such to best fit the customer's needs.

1-7. (canceled)

8. A hearing device, the hearing device comprising:
a housing comprised of titanium,
wherein an arithmetical mean roughness of a surface of the housing is 0.7-1.8 μm.

9. The hearing device of claim 8, wherein the arithmetical mean roughness is based on International Organization for Standardization (ISO) 4287 or ISO 4288.

10. The hearing device of claim 8, wherein the surface of the housing was formed by vibratory grinding.

11. A method of manufacturing a housing for a hearing device, the method comprising:
designing a model of a housing for a hearing device using a modeling software;
based on the model, generating a preform of the housing from a metal powder including titanium; and
treating a surface of the preform such that the arithmetical mean roughness of the surface is 0.7-1.8 μm.

12. The method of claim 11, wherein the arithmetical mean roughness is based on International Organization for Standardization (ISO) 4287 or ISO 4288.

13. The method of claim 11, wherein generating the preform including selective laser melting.

14. The method of claim 11, wherein the treating the surface comprises vibratory grinding.

15. The method of claim 14, wherein the treating the surface further comprises sand blasting.
